(19) United States
(12) Patent Application Publication
(10) Pub. No.: US 2011/0274894 A1
(43) Pub. Date: Nov. 10, 2011

(54) Durable In-Mold Decoration Laminates Using Semi-Crystalline Polymer as Top Film

(75) Inventors: Ming Kun Shi, Arcadia, CA (US); Christine U. Dang, Garden Grove, CA (US); John J. Markey, Flossmoor, IL (US)

(73) Assignee: AVERY DENNISON CORPORATION, Pasadena, CA (US)

(21) Appl. No.: 13/145,227

(22) PCT Filed: Jan. 19, 2010
(86) PCT No.: PCT/US10/21433

§ 371 Date: Jul. 19, 2011

Related U.S. Application Data
(60) Provisional application No. 61/145,616, filed on Jan. 19, 2009.

(51) Int. Cl. B32B 3/00; B41F 33/00

(52) U.S. Cl. 428/195.1; 101/483

(57) ABSTRACT

This specification discloses durable In-Mold Decoration (IMD) laminates made by using semi-crystalline polymers as top films. The crystalline structure or content of the semi-crystalline polymer can be optimized with a post process treatment process, which leads to improved chemical resistance and scratch resistance. The post process treatment can be conducted after the making of the film, during the in-mold processing of the laminate or after the in-mold processing of the laminate. The treatment can be applied over the entire film surface or in discrete areas with the treatment depth ranging from the top surface up to the bottom surface of the film. The post process treatment can be accompanied by changes in the appearance of the top film which makes IMD products tunable in decoration luster appearance. Durable IMD laminates with 60 degree gloss value of greater than 90 and process of making such laminates are also disclosed.

### TECHNICAL FIELD

This specification relates to durable In-Mold Decoration (IMD) products and/or more particularly to decoration laminates for the same which have top films that are made by using semi-crystalline polymers. Notably, such top films made from these polymers can be easily processed with deep draw ratios by in-mold processing and their chemical resistance and scratch resistance are significantly improved by a post treatment process which introduces more crystals into the polymer films. The post process treatment may be accompanied by changes in the appearance of the films which makes IMD products tunable in decoration luster appearance.

### BACKGROUND

In-Mold Decoration (IMD) is popular for making and decorating three-dimensional plastic products, e.g., for applications in electronic packaging, medical devices, household containers, etc. IMD is commonly a low cost process for making products that exhibit good aesthetic appearance and long-term durability. A typical decoration laminate suitable for use in an IMD process includes a top film with a top surface and a bottom surface and a decorative luster pattern. The decorative luster pattern is usually printed on the bottom surface of the top film and is protected by the top film for long-term durability. An optional thermoplastic layer can be applied over the luster pattern, i.e., on the back side or opposite surface of the decoration luster pattern, to protect the decoration luster pattern from damage, e.g., during thermoforming and injection molding. An optional carrier film can be positioned on the top surface of the top film to protect the top film, e.g., from scratches during handling and processing. Commonly, the carrier film is peeled off either before or after processing of the IMD laminates. In practice, the IMD laminate is thermoformed, trimmed and placed in a mold for injection molding to create a rigid three-dimensional part or product decorated with the laminate on a surface of the part or product.

Often, it is desirable that IMD products, e.g., such as those used for automotive decoration, meet a stringent set of testing specifications, which can present big challenges to both the laminate designers and part manufacturers in the selection and processing of materials. The criteria commonly include aesthetic appearance, chemical resistance, scratch and mar resistance, and ease of processability by the in-mold process which includes thermoforming, trimming and injection molding. Most of these properties are determined solely or to a large extent by the top film in the laminate. The top film is directly exposed to the outside environment during application and consequently, the chemical resistance and scratch resistance are determined largely by the top film. On the other hand, the optical clarity, the surface roughness, the film thickness and the dimensional stability have big impact on the aesthetic appearance such as gloss, the depth of image and the Distinctiveness Of The Image (DOI). The top film also plays a big role in the processability of the laminate. Often, it is desirable that the top film be able to withstand up to 300% elongation at the forming temperature without breaking, conform to the shape of the mold with well defined corners, and be trimmed at room temperatures without cracking and without generating too much dust.

Many materials have been used as top films to make IMD laminates such as poly(vinyl chloride) (PVC), poly(urethane) (PU), polycarbonate (PC), acrylic such as poly(methyl methacrylate) (PMMA), mixtures of poly(vinylidene difluoride) and acrylic, celluloses, etc. While each of these materials have certain desirable qualities, no one generally has all the qualities at the level desired by many Original Equipment Manufacturers (OEM)s. In particular, these films tend to show some degree of damage after chemical resistance tests which include exposure to gasoline, common chemicals, and cosmetic products. In particular, it has been very challenging to resist insect repellent and sunscreen lotion testing liquids when this testing is conducted at high temperatures. Resulting damage to the top film in response to such testing adversely affects the visual appearance of the underlying decoration luster.

In order to make a more durable IMD product, a protective topcoat has been applied to the surface of some top films such as PC and PMMA. However, during some chemical resistance tests, the testing liquids can penetrate through the topcoat and damage the substrate (i.e., top film) beneath. In addition, the topcoat may have different thermal and mechanical properties than the substrate and shrinkage, cracking and delamination often occur during thermal processing steps wherein the laminate undergoes severe stretching, particularly in deep draw areas. To address the cracking issue, a two-step sequential curing process, such as thermal and radiation curing or radiation and thermal curing process, has been used in making the top film or the topcoat. In the first step, the top film or the topcoat is only partially cured so that it retains certain flexibility. After going through printing, thermoforming, trimming and injection-molding, the film is exposed to radiation or heat again to harden the surface. Such a sequential process, however, can have certain drawbacks. First, the final curing is generally conducted on a solid material, and since the active sites typically have very limited mobility in a solid media, the amount of crosslink reactions created by the curing is very limited. Second, the two-step process adds an additional step that commonly has to be done by the customers after thermal processing of the laminate, which generally increases the cost. Furthermore, films or topcoats cured by radiation often suffer from excessive shrinkage during thermal processing and the products made using such films are difficult to process.

To address the foregoing issues, a new top film having excellent chemical resistance and scratch resistance and yet easily processable is desirable for making decoration laminates and/or durable IMD products therefrom with high quality aesthetic appearance. Accordingly, disclosed herein are films made from semi-crystalline polymers to be used as top films for IMD laminates and durable IMD products made with such IMD laminates. The disclosed top films can be easily thermoformed and tend to have chemical and scratch resistance that is significantly improved by post process treatment which increases the crystal content of the top film. The post process treatment may be accompanied by changes in the appearance of the top films which makes IMD products tunable in decoration luster appearance.

### SUMMARY

In accordance with one embodiment, an in-mold decoration (IMD) laminate is provided including: a top film and a decorative luster pattern, wherein the top film is a semi-crystalline polymer selected from the group consisting of an aliphatic cyclic polyamide, aromatic polyamide, and polyester.

In accordance with another embodiment, a method of creating a decoration laminate is provided, including the steps of: preparing a semi-crystalline polymer film; printing a decoration luster pattern on the bottom surface of the semi-crystalline polymer film; and optimizing the crystallinity structure of the semi-crystalline polymer film.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter disclosed herein may take form in various components and arrangements of components, and in various steps and arrangements of steps. The drawings are only for purposes of illustrating preferred embodiments and are not to be construed as limiting. Further, it is to be appreciated that the drawings may not be to scale.

FIG. 1 is a diagrammatic illustration showing an exemplary IMD laminate in accordance with aspects of the present inventive subject matter, the illustrated embodiment including a top film with a decoration luster pattern applied to the bottom surface thereof.

FIG. 2 is a diagrammatic illustration showing another exemplary IMD laminate in accordance with aspects of the present inventive subject matter, the illustrated embodiment including an optionally thermoplastic layer.

FIG. 3 is a diagrammatic illustration showing various application patterns for the application of a post process treatment to be applied to the top film of a IMD laminate in accordance with aspects of the present inventive subject matter.

FIG. 4 is a diagrammatic illustration showing another exemplary IMD laminate in accordance with aspects of the present inventive subject matter, the illustrated embodiment including textures on a top surface of the top film.

FIG. 5 is a diagrammatic illustration showing the structure of an exemplary material used for the top film of a IMD laminate in accordance with aspects of the present inventive subject matter.

FIG. 6 is a graph showing DSC measurements obtained from an exemplary sample of a top film (i.e., example 1) made in accordance with aspects of the present inventive subject matter.

FIG. 7 is a graph showing DMA measurements obtained from an exemplary sample of a top film (i.e., example 1) made in accordance with aspects of the present inventive subject matter.

FIG. 8 is a graph showing stress-strain measurements obtained from an exemplary sample of a top film (i.e., example 1) made in accordance with aspects of the present inventive subject matter.

FIG. 9 is a graph showing DMA measurements obtained from an exemplary sample of a top film (i.e., example 1) made in accordance with aspects of the present inventive subject matter.

FIG. 10 is a graph showing E′ measurements obtained from an exemplary sample of a top film (i.e., example 1) made in accordance with aspects of the present inventive subject matter.

FIG. 11 is a graph showing stress-strain measurements obtained from an exemplary sample of a top film (i.e., example 1) made in accordance with aspects of the present inventive subject matter.

FIG. 12 is a graph showing DSC measurements obtained from an exemplary sample of a top film (i.e., example 1) made in accordance with aspects of the present inventive subject matter.

FIG. 13 is a graph showing optical property measurements obtained from an exemplary sample of a top film (i.e., example 2) made in accordance with aspects of the present inventive subject matter.

FIG. 14 is a graph showing hardness measurements obtained from an exemplary sample of a top film (i.e., example 2) made in accordance with aspects of the present inventive subject matter.

### DETAILED DESCRIPTION

For clarity and simplicity, the present specification shall refer to structural and/or functional elements, relevant standards, protocols and/or processes, and other components that are commonly known in the art without further detailed explanation as to their configuration or operation except to the extent they have been modified or altered in accordance with and/or to accommodate the preferred embodiment(s) presented herein.

This specification discloses durable In-Mold Decoration (IMD) laminates made by using semi-crystalline polymers as top films. The crystalline structure and/or content of the semi-crystalline polymer can optionally be optimized with a post process treatment process, which leads to further improved chemical resistance and scratch resistance. The post process treatment can be conducted at any stage during the process, such as after the making of the top film, or during making of the laminate, or during the in-mold process, or after the in-mold process. The treatment can be applied over the entire top film surface, throughout the top film thickness, or in discrete areas. The post process treatment can be accompanied by changes in the appearance of the top films which makes IMD products tunable in decoration luster appearance. Durable IMD laminates and the process of making such laminates are also disclosed.

Polymers suitable for use as a top film in accordance with the present disclosure and/or suitable for the post processing treatment disclosed herein to optimize the crystalline structure and/or content, include polypropylene (PP), polyester (PE), poly(ethylene terephthlate) (PET), PMMA, polyamides (PA)s, etc. Among these polymers, an aliphatic cyclic polyamide or aromatic polyamide and an amorphous PET (a-PET) are particularly advantageous. In one suitable embodiment, the semi-crystalline polymer consists of a polyamide film extruded from a resin, i.e., an aliphatic cyclic polyamide or aromatic polyamide. Such a resin is commercially available, e.g., from Evonik Degussa, which produces and/or otherwise provides the resin under the name TROGAMID®. In another suitable embodiment, the semi-crystalline polymer consists of an amorphous poly(ethylene terephthlate). Suitably, the post process treatment can be introduced by different means and either before, during or after processing of the decoration laminates. The post process treatment may be accompanied by changes in the appearance of the top films which in turn makes IMD products tunable in decoration luster appearance.

In connection with the development of the present inventive subject matter, various samples were prepared and tested. The sample preparation and testing methods are described below.

Description of Testing and/or Sample Preparation Methods:

The following tests were used to evaluate the performance of sample top films:

1. Optical Testing:

The optical transmission and absorption spectra were recorded using a Perkin-Elmer UV/Vis spectrometer (Lambada 20). The optical transmission %, haze % and clarity % were recorded using a Gardener Haze-Guard-Plus instrument. Gloss measurement was performed using a BYK Gardener gloss meter (Micro-TRI-gloss) at 60 degree angle. For the gloss measurement, the sample was placed on a stack of white paper. For the haze % and gloss measurements, at least three tests were taken at different areas and the average value was reported.

2. Chemical Resistance Testing:

Isopropanol and Toluene test: A small piece of sample was dipped into isopropanol (IPA) and toluene, respectively, in a closed bottle for 1 hr. After the test, the sample was taken out of the bottle, washed with IPA and visually inspected for any damage such as changes in optical clarity, spotting, breaking, etc.

Insect Repellent test: The test was conducted per Ford DVM-0039-MA procedure. A Deep Woods (S.C. Johnson & Son Inc., WI) Insect Repellent liquid was used for the test. The Deep Woods product consists of 25% of N,N,-diethyl-meta-toluamide in isopropanol. The test was performed both at room temperature and at high temperatures for 1 hr. A 2×2 inch square fabric (TESTFABRICS, Inc., PA) was placed on the surface of the film. Three droplets of the Deep Woods liquid were applied onto the fabrics in the same area using a transfer pipette. An aluminum plate was placed over the fabric and a 500 g weight was placed on the aluminum plate, on the area where the liquid was applied. The sample was kept at room temperature for 1 hr. for testing at room temperature. For testing at high temperatures, the sample was placed in a ventilated thermal oven set at the desired temperature for 1 hr. After testing, the fabric was removed and the film was washed thoroughly using a detergent solution, wiped dry, and visually inspected for any damage to the surface such as swelling, spotting, fabric impression, etc. A rating of 1 to 5 was assigned to evaluate the performance, with rating “1” being the best (no damage at all) and “5” the worst.

Sunscreen Lotion test: The test was conducted per Ford DVM-0036-MA procedure. A Coppertone 50 SPF Sunscreen with Avobenzone (Schering-Plough Health Care Products Inc., TN) was used for the test. The test was performed both at room temperature and at high temperature for 1 hr. A 2×2 inch square fabric (TESTFABRICS, Inc., PA) was placed on the surface of the film. A drop of the Coppertone paste was applied onto the fabric. An aluminum plate was placed over the fabrics and a 500 g weight was placed on the aluminum plate, on the area where the liquid was applied. The sample was kept at room temperature for 1 hr for testing at room temperature. For testing at high temperature, the sample was placed in a ventilated thermal oven set at the desired temperature for 1 hr. After testing, the fabric was removed and the film was washed thoroughly using a detergent solution, wiped dry, and visually inspected for any damages to the surface such as swelling, spotting, fabric impression, etc. A rating of 1 to 5 was assigned to evaluate the performance, with rating “1” being the best (no damage at all) and “5” the worst.

Sunscreen Lotion and Insect Repellent Resistance test: The test was conducted per GM GMW14445 procedure. The test solution was made of equal parts by weight of DEET, 3-(4-Methoxyphenyl)-2-propene acid-2-ethyl-hexylester (octyl Methoxycinnamate), 2-Ethylhexyl-2-cyano-3,3-diphenylacrylate (octocrylene) and 3,3,5-Trimethylcycloheaxylsalicylate (Homosalate). Drops of the test liquid (approximately 50 μl) were applied to the surface of the test sample in at least three different places using a transfer pipette. The test sample was placed in a thermal oven for 1 hr. at 80±3° C. After removing from the oven, the sample was cooled to the room temperature, cleaned with a detergent solution and wiped dry, and visually inspected for any damages such as swelling, blistering, creasing, spotting, etc. A rating of 1 to 5 was assigned to evaluate the performance, with rating “1” being the best (no damage at all) and “5” the worst.

Air Freshener test: A Car Freshener “Royal Pine” was put in direct contact with the film sample and covered with an Al plate. A 500 g weight was applied on the Al plate and kept for 20 hrs. After testing, the sample was visually inspected for damages such as swelling, spotting, etc.

3. Dynamic Modulus Analysis:

Samples were characterized using a TA Instrument RSA III instrument with rectangular torsion geometry. A 5 mm×14 mm strip of 300 mm thick sample top film was used. The test was performed using temperature sweep from 25° C. to 240° C. at 3° C./step rate and 10 rad/second frequency. The G′, G″ and Tan-delta were recorded as a function of temperature.

4. Stress-Strain Measurements:

The stress-strain measurements were taken to assess the thermoforming properties of the top film samples. The films were stretched on an Instron 4501 at 300 mm/min at temperatures between the glass transition temperature measured using DSC and the melting temperature of the polymer films. The stress and strain %, defined as the ratio % of elongated length (ΔL) divided by the initial length (Lo) curves were recorded at various temperatures to assess the thermoforming performance.

5. Thermoforming Tests:

Vacuum thermoforming tests were conducted on a MAACO vacuum forming unit that is equipped with a slow oven setting (SEJI condition). A thermoforming platen of 11″ long, 4″ wide and 1″ deep was used. An infra-red sensor was taped at the center of the film which automatically initiates the thermoforming process once the film reaches the heating temperature. After thermoforming, the draw ratio and the sharpness of the corners was inspected to evaluate the thermoforming quality.

6. DSC Measurements:

The samples were characterized using TA Instruments DSC Q2000 to measure the glass transition temperature (Tg), cold crystallization temperature (Tc) and melting temperature (Tm). The measurements were made using an Al sample pan and liquid nitrogen as purging gas. Samples of 1.5 mg to 2.2 mg were placed into the Al pan and modulated at ±0.796° C. every 60 seconds. The temperature ramp from 0° C. to 300° C. was conducted at 5° C./min ramp rate. Tc and Tm analysis were made based on the heat flow.

7. Gravure Printing:

A lab scale gravure printing proofer (K Printing Proofer, RK Print Coat Instruments, UK) was used to print images on semi-crystalline top films. Woodgrain image and solid color layer were printed using solvent based gravure printing inks made by Avery Performance Film Division. After printing, the samples were placed in a thermal oven to dry off the solvent.

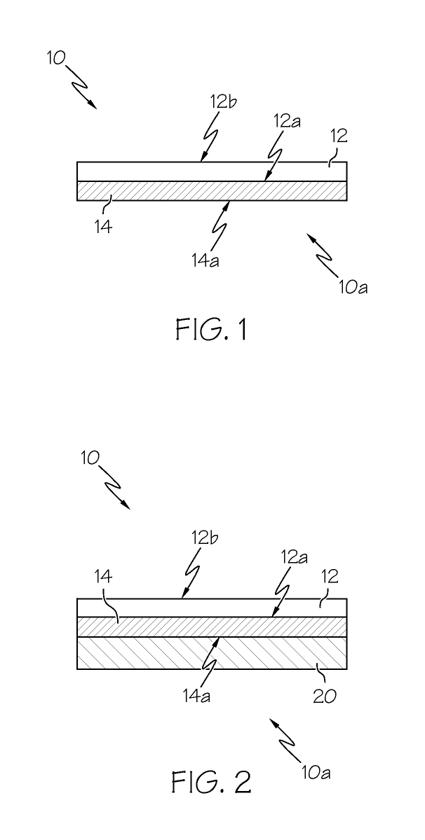

With reference now to FIG. 1, there is illustrated an exemplary durable In-Mold Decoration (IMD) laminate 10 made by using a semi-crystalline polymer as a top film 12 in accordance with a suitable embodiment of the present inventive subject matter. As shown, a decoration luster pattern 14 is printed or otherwise applied to the back or bottom surface 12a of the top film 12.

Suitably, the crystalline structure and/or content of the semi-crystalline polymer used for the top film 12 is optimized with a post process treatment that leads to further improved chemical resistance and/or scratch resistance. Polymers that are suitable for this post process treatment include polyethylene, polypropylene, polyester, poly(ethylene terephthlate), PMMA, polyamides, etc. Among these polymers an aliphatic cyclic polyamide or aromatic polyamide (e.g., such as TROGAMID® or the like) and amorphous PET are particularly advantageous. These types of polymers have excellent optical clarity, good resistance to gasoline and common organic solvents, good scratch resistance and are easily processable by in-mold process. Optionally, additives such as thermal stabilizers and UV stabilizers, pigments and processing aids can be added to the semi-crystalline polymer used for the top film 12.

The thickness of the semi-crystalline top film 12 is preferably from 0.1 μm to 5 mm, more preferably from 0.1 mil to 20 mil, and most preferably from 0.1 mil to 15 mil. While not shown, optionally, a removable protective carrier film can be positioned or applied onto the top surface 12b or both the top and bottom surfaces (12b and 12a) of the film 12 to protect this latter, e.g., from scratching during transportation, handling and subsequent processing steps. The carrier film can be removed before printing of the decoration luster pattern 14, after printing of the decoration luster pattern 14 but before thermoforming or after in-mold processing. When the top film 12 is relatively thin, e.g., such as less than 1 mil, the carrier film serves as a support to provide enough strength to the top film 12 so that it does not break during film making or subsequent processing steps.

The surface of the protective carrier film that is in contact with the semi-crystalline polymer film 12 may be smooth or textured. However, smooth surface improves the surface roughness and consequently, the optical gloss, of the extruded semi-crystalline polymer film 12. Accordingly, the surface roughness of the carrier film is preferably less than 100 nm, more preferably less than 30 nm, and most preferably less than 15 nm. Alternately, a surface textured carrier film, on the other hand, can be used to transfer a desired texture formed on a surface of the carrier film directly to the semi-crystalline film 12. Suitably, the texture can be made by etching, printing, embossing, mechanical brush, etc.

Optionally, a primer layer (not shown) can be applied onto the bottom surface 12a of the semi-crystalline polymer film 12 prior to printing the decoration luster pattern 14 to improve its compatibility and adhesion with the printed decoration luster pattern 14. Alternately, the bottom surface 12a of the semi-crystalline polymer film 12 can be treated by plasma, corona, flame or other techniques to improve its adhesion with the printed ink layer 14.

Suitably, the decorative luster pattern 14 is printed onto the bottom surface 12a of the semi-crystalline polymer film 12 by any conventional printing technique such as gravure printing, screen printing, flexography, etc. using water, solvent or UV curable inks, by digital printing using inkjet printing by solvent and UV curable inks, laser printing using toner cartridge, dye-sublimation, etc. Using conventional printing, the decoration luster pattern may comprise several layers including but not limited to a grain ink layer, a metallic ink layer, a color background layer, etc. In the absence of an optional thermoplastic layer 20 (e.g., as shown in FIG. 2), special high temperature inks capable of withstanding the injection molding process are suitably employed. Examples of suitable printing inks include NORIPHAN® inks made by Proëll for screen printing and solvent based gravure printing inks made by Avery Dennison Performance Film Division. Because of its high temperature resistance, the top film 12 (e.g., made for TROAMID® and/or other like resins) is particularly suitable for laser and dye-sublimation printing. In such an embodiment, since the ink is diffused inside the film 12 in dye-sublimation printing, the decoration pattern can be printed either on the top or the bottom surface (12b or 12a) of the film 12. Optionally, the decoration luster pattern 14 can further be created by etching, such as by using laser or plasma techniques.

With reference now to FIG. 2, in one exemplary embodiment, an optional thermoplastic layer 20 can be applied to the bottom surface 14a of the decorative luster pattern 14 either by coating, thermal lamination or via an adhesive (not shown). The thermoplastic layer 20 may play several functions. For example, it protects the printing ink from washing-off by, and ensures good adhesion to, the injection resin during injection molding which is carried out at high temperatures and high pressure. It may also serve as a complementary color layer so that the color of the decoration luster will not be affected after thermoforming, particularly after deep draw forming. For this reason, the color of the thermoplastic layer 20 used may be close to the color of the decoration luster 14. The thermoplastic layer 20 further serves as an opacity layer so that the color of and the defects generated from the injection resin will not adversely affect the decoration luster 14.

In embodiments where the semi-crystalline polymer film 12 is thin and does not have enough strength, the thermoplastic layer 20 further provides additional rigidity to the laminate 10 so that it can go through the thermoforming and trimming process without breaking. Suitable thermoplastic layers 20 include, but are not limited to, acrylonitrile-butylene-styrene (ABS), PC, polyamide, polyester, acrylic, etc. ABS is particularly advantageous because of its low cost, high temperature resistance and good adhesion to the injection molding resin based on ABS and ABS/PC blends. The thickness of the optional thermoplastic layer 20 can range from 0.1 μm to 20 mils, preferably from 1 μm to 17 mils. Suitably, the laminate 10 is processed using any conventional thermoforming and trimming methods and injection molded from the back surface 10a thereof.

Optionally, the semi-crystalline polymer film 12 can be used as a single film or a top layer in a multilayered film, e.g., as illustrated in FIG. 2. In the multilayered film, the semi-crystalline polymer film 12 protects the substrate and/or underlying layers from chemical and scratch damage. The multilayered film is optionally made by different techniques such as by thermal lamination, by using an adhesive, by co-extrusion, etc. Many thermoplastic polymer materials may be used as the substrates such as polyamide, PC, polyurethane, polyvinyl chloride, polyolefins, acrylic and methacrylic polymers or copolymers, ABS, etc. The thickness of the substrate preferably ranges from 1 mil to 50 mils, more preferable from 2 mil to 20 mils, and most preferably from 5 mil to 15 mils.

A protective carrier film (not shown) is optionally positioned on and/or applied to the surface 12b of the semi-crystalline polymer film 12, e.g., to protect the surface 12b from scratches during transportation and handling. Suitable protective polymer carrier films include polyethylene, polypropylene, polyester, polyamide, etc. The protective carrier film can be removed before making of the laminate 10, after making of the laminate 10 but before in-mold processing or after in-mold processing of the laminate 10.

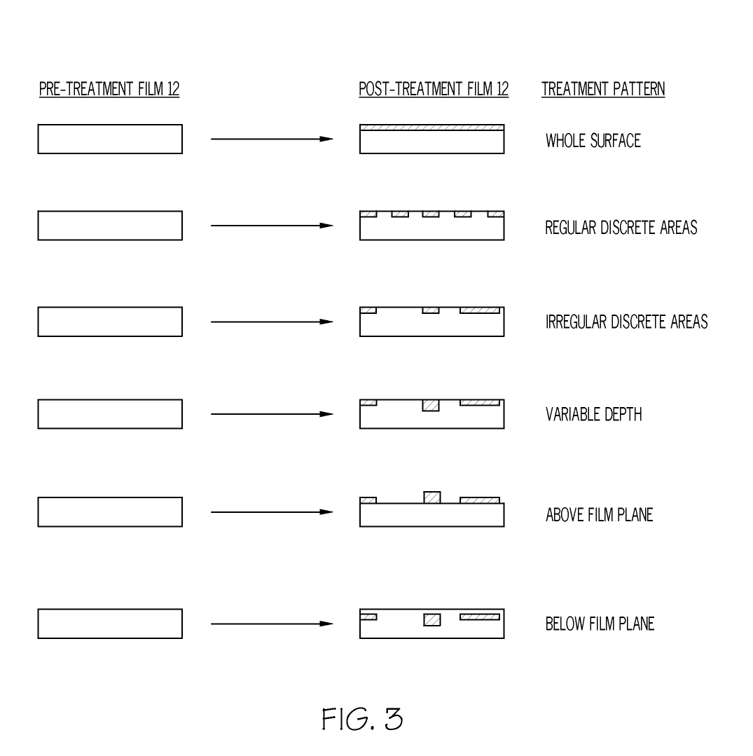

As previously mentioned herein, the semi-crystalline polymer film 12 is optionally treated to optimize the crystallinity and content, which leads to improved chemical resistance and scratch resistance. The treatment of the semi-crystalline polymer film 12 is optionally conducted over the entire surface or in discrete areas; with the treatment depth extending from the top surface toward the bottom surface, and in both regular and irregular geometries. Various example application patterns of the treatment are illustrated in FIG. 3, where the hatched regions represent areas of the film 12 that have received the applied treatment. As is to be appreciated, the treatment in discrete areas create regions with different physical and/or chemical properties, and as shown, the treated areas may be above or below the film plane.

While thermal treatment via convection heating is optionally employed to achieve the aforementioned optimization, it is to be understood that the treatment of the semi-crystalline film 12 may alternatively be accomplished by many different techniques. For example, it can be achieved by contact heating from a metal surface, irradiation of infra-red or laser, plasma treatments, etc. Among these techniques, convection heating is advantageous because it does not cause any significant damage to the surface and to the chemical composition of the film 12.

Optionally, discrete treatment is obtained by using focused energy sources, by heating through a patterned mask, embossing etc. Suitably, the depth of the treatment is controlled by the total energy delivered to the treated areas.

In one suitable embodiment, a treatment device is integrated into the extrusion line extruding the film 12 to conduct the treatment in-line. For example, a thermal oven or an infra-red heater can be added at the end of extrusion to conduct the thermal treatments.

Alternatively, the post process treatment is realized during printing of the decoration luster 14, where the film is heated by drying of the printing inks, laser etching, etc. Advantageously, such treatment eliminates a separate treatment step.

Alternatively, the post process treatment is realized during in-mold processing of the laminate, which also eliminates the separate treatment step. Indeed, improved chemical resistance has been observed after thermoforming of 6 mil and 12 mil thick top films 12 (e.g., such as those made from the TROGAMID® resin) under the conditions described herein.

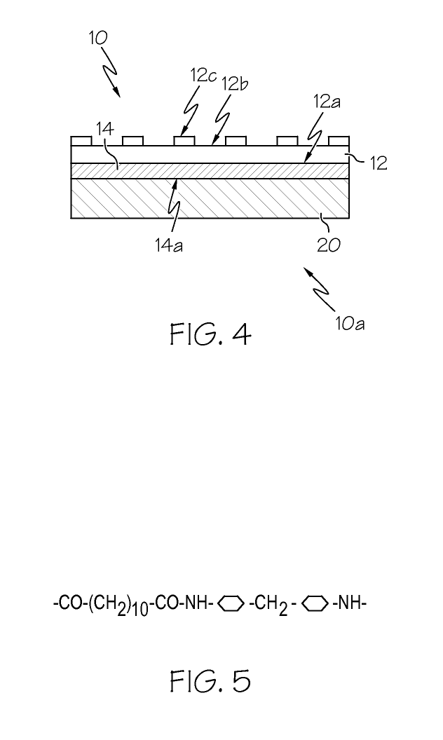

In one optional embodiment, textures 12c such as dots, squares, primes, etc. are created onto the top surface 12b or both the top and bottom surfaces (12b and 12a) of the semi-crystalline polymer film 12 to achieve different aesthetic appearance, e.g., as illustrated in FIG. 4. The textures 12c may consist of regular patterns or irregular patterns. Such textures 12c can be created by printing, embossing, replication, etching, etc. The textures 12c are optionally created on the top surface 12b of the semi-crystalline polymer film 12 during in-mold processing of the laminate 10, by for example, replicating the surface texture of the mold.

### EXAMPLES

### Example 1

### Semi-Crystalline Polyamide Film

As a first example top film 12 of a laminate 10 for making durable IMD products, a semi-crystalline, micro-crystalline polyamide film was extruded from resins belonging to the polyamide family of materials and made by condensation reaction of a cycloaliphatic diamine and a dodecanedioic acid, the structure of which is illustrated in FIG. 5. In this example, TROGAMID® resins were used. Because of the presence of cycloaliphatic segment, the material is only micro-crystalline and films made from this material are crystal clear. The presence of sub-micron crystals make the films highly resistant to common chemicals, more abrasion resistant than common acrylic and polycarbonate films and yet easily processable by in-mold processing. Films of different thicknesses can be made by extrusion.

Some key properties of the films made in accordance with example 1 are listed in table 1.

TABLE 1

| Parameters | Values | Parameters | Values |
|---|---|---|---|
| Density | 1.02 g/cm3 | Abrasion resistance | >PMMA and |
| | | | PC |
| Refractive index | 1.51 | Scratch resistance | >PC; = PMMA |
| Transmission* | 92% | Elongation at 25° C. | >50% |
| Tg [° C.] | 140 | Resistance to IPA | Yes |
| Tc [° C.] | 160 | Resistance to Acetone | Yes |
| Tm [° C.] | 250 | Resistance to Toluene | Yes |
| Young's Modulus | 1400 MPa | Resistance to Xylene | Yes |
| Shore hardness | 81D | Resistance to UV | Yes |

*Measured using UV/Vis Spectrometer

The example 1 film has excellent optical clarity characterized by a high optical transmission % comparable to glass. The film has a glass transition temperature (Tg) of about 140° C., a cold crystallization temperature of about 160° C. and a melting temperature of about 250° C. Because the size of the crystal is smaller than the visible light, the presence of crystals does not adversely affect the optical clarity of the film. The film also exhibits good abrasion resistance and scratch resistance, equal to or better than PMMA and PC. The big difference between the glass transition (Tg) and the melting temperature (Tm) provides a wide operating window for subsequent processing steps. The example 1 material shows excellent resistance to common organic solvents and chemicals such as alcohol (IPA), acetone, toluene and xylene. The density of the example 1 resin, being 1.02 g/cm³, about 20-30% lower than acrylic and polycarbonate materials, makes it very attractive for making decoration products with lighter weight.

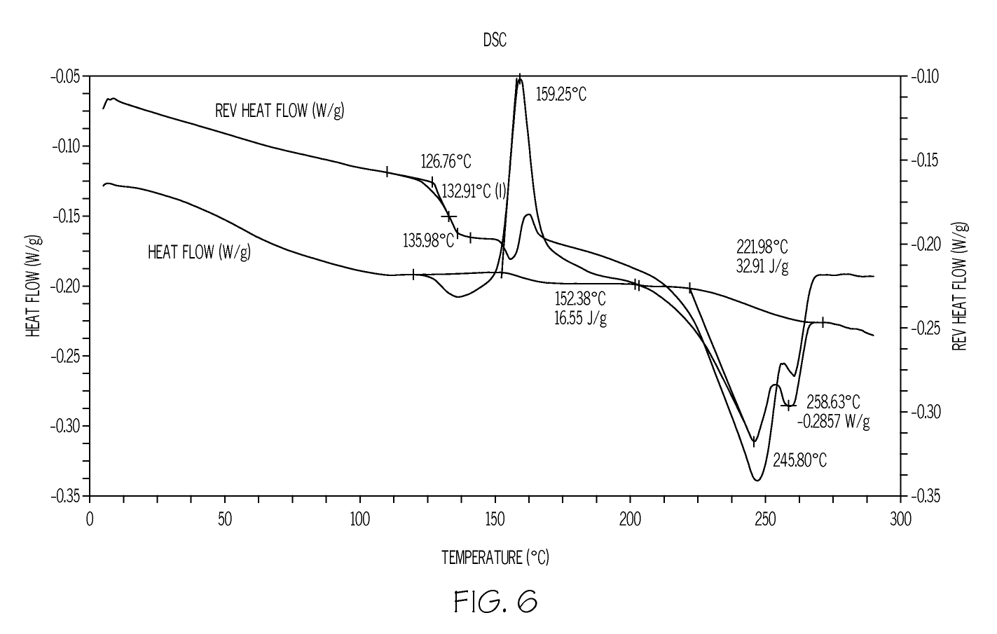

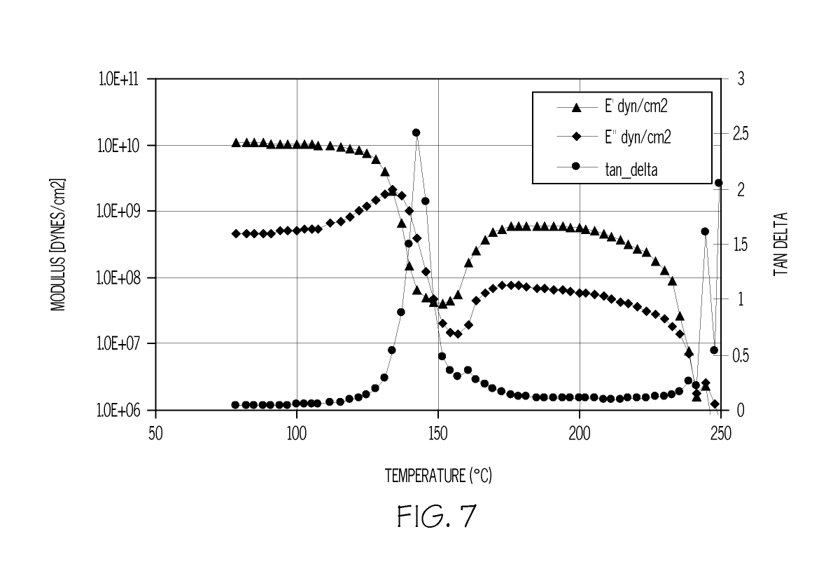

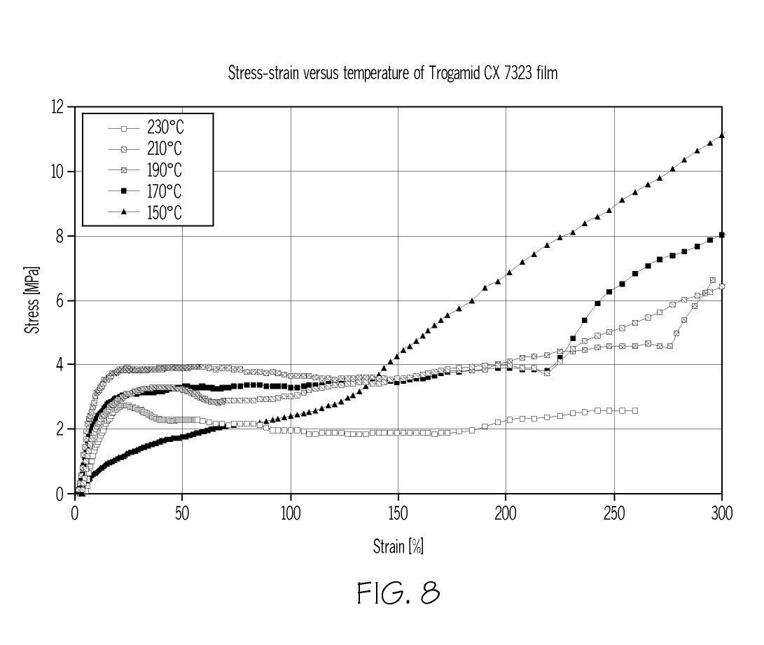

Thin films according to example 1 were obtained by extrusion of TROGAMID® resins, and in particular, the TROGAMID® resin designated by the product code CX7323. The DSC curve of one such film (12 mil thick) is shown in FIG. 6. The film shows a glass transition temperature of abut 133° C., a cold crystallization temperature of about 159° C. and a melting temperature of 246° C. These values are comparable to those reported in Table 1. The DMA measurement (as shown in FIG. 7) of the extruded film shows a Tg of 142° C., which is higher than that obtained from the DSC measurement and closer to that reported in Table 1. The different Tg values measured by the DSC and DMA is caused by the different heating rate and testing frequency during the measurement.

As shown in FIG. 7, the E′ decreases starting at about 130° C. due to softening of the film around the glass transition temperature. The E′ reaches a minimum at around 150° C., and increases upon further increase in temperature to 170° C. Thereafter, the E′ remains relatively stable until about 220° C. before decreasing again near the melting temperature. The increase in E′ above 150° C. can be attributed to further crystallization by heating. The variation of the E′ value from 170° C. to 220° C. reflects two opposite effects: increase by further crystallization and decrease by heat induced softening.

In order to assess the thermoforming properties of the example 1 film, particularly after thermal treatment which makes the film more rigid, stress-strain tests were performed on both the pristine and thermally treated example 1 films (again 12 mil thick). The tests were performed on an Instron 4501 at temperatures between 150° C. and 190° C. A 12.5 mm wide by 50.8 mm long film strip was stretched at 300 mm/min speed and the stress and strain % curves were recorded. As shown in FIG. 8, the film can be stretched to more than 300% strain at temperatures between 150° C. to 190° C. without breaking. The film showed little to no contraction after being removed from the sample holder. This characteristic is very important for IMD products where shrinkage after processing can cause many detrimental effects such as cracking, delaminating, deforming, image distortion, etc. For the film stretched at 150° C., the stress continuously increases with increasing temperature. For films stretched at between 160° C. to 190° C., however, the stress curve is more complicated. This latter phenomena is again associated with two opposite effects: decrease due to softening and increase due to further crystallization induced by both stretching and heating.

Vacuum thermoforming tests were conducted using 6 mil and 12 mil thick example 1 films on a MAACO thermoforming unit. A platen 11″ long, 4″ wide and 1″ deep was used. The test was performed under the following conditions: 180° C. to 200° C. heating temperature; 19 sec thermal heating time; 15 sec thermoforming time, and 50 psi platen pressure. An infra-red sensor taped at the center of the film automatically initiates the thermoforming process once the film reaches the heating temperature. Both films were formed into 3D shapes with well defined corners.

Because of its excellent thermal resistance, the film of example 1 is particularly suitable for printing using laser and dye-sublimation methods. The high glass transition temperature also provides good dimensional stability during printing and drying using solvent based inks so that good registration can be obtained when one then another ink layer is printed. The hard surface of the film also resists deformation and surface roughening during subsequent processing steps.

Improved Chemical Resistance by Post Treatment

For automotive applications, the top film 12 not only benefits from having good resistance to gasoline and common chemicals but also to some cosmetic products such as the insect repellent liquids, sunscreen lotions, air freshener etc. The resistance of the example 1 film to these cosmetic products is listed in Table 2. For comparison, a PC film (LEXAN® 8010) obtained from Sabic Group and a PC film with a topcoat layer (XTRAFORM®) obtained from MacDermid Corp. were also tested. While all these films show good resistance to the insect repellent and sunscreen lotion at room temperatures, the PC film and topcoated PC film are severely damaged by the insect repellent and sunscreen lotion at 74° C., both showing a rating “5” in the degree of damage. The example 1 film, on the other hand, shows excellent resistance to sunscreen lotion at 74° C. but is also damaged, though to a lesser extent, by the insect repellent at 74° C., with a rating “3”.

TABLE 2

| | Insect | Insect | | | |
|---|---|---|---|---|---|
| | Repellent | Repellent | Sunscreen | Sunscreen | Air |
| Samples | 23° C. | 74° C. | 23° C. | 74° C. | Freshener |
| Comparative | 1 | 5 | 1 | 5 | NA |
| PC film | | | | | |
| Comparative | 1 | 5 | 1 | 5 | NA |
| top coated | | | | | |
| PC film | | | | | |
| Example 1 | 1 | 3 | 1 | 1 | 1 |
| film | | | | | |

Rating
“1”: no visible damage;
“3”: slight damage;
“5”: severe damage

Notably, the insect repellent test is very challenging for plastic films particularly at high temperatures because the DEET compound can soften the plastic materials and the pattern of the testing fabric gets easily impressed onto the polymer surface. For a multilayered film, the DEET compound can even penetrate through the top layer and causes delamination and damages the substrate beneath. These detrimental effects explain why many current commercial IMD products are not able to sufficiently withstand the insect repellent test.

In order to further improve the resistance of the example 1 film to the insect repellent liquid, thermal treatment was performed in a thermal oven at temperatures ranging from 160° C. to 190° C. for 3 min to 10 min. After thermal treatment, the chemical resistance, the optical clarity, the scratch resistance and thermoforming properties were characterized. These results are summarized in Table 3.

TABLE 3

| | Insect | Insect | | | |
|---|---|---|---|---|---|
| | Repellent | Repellent | Sunscreen | Sunscreen | Air |
| Samples | 23° C. | 74° C. | 23° C. | 74° C. | Freshener |
| Control | 1 | 3 | 1 | 1 | 1 |
| Treated: | 1 | 3 | 1 | 1 | NA |
| 110° C.- | | | | | |
| 150° C./ | | | | | |
| 10 min | | | | | |
| Treated: | 1 | 3 | 1 | 1 | NA |
| 160° C./ | | | | | |
| 7 min | | | | | |
| Treated: | 1 | 1 | 1 | 1 | NA |
| 160° C./ | | | | | |
| 10 min | | | | | |
| Treated: | 1 | 3 | 1 | 1 | NA |
| 190° C./ | | | | | |
| 5 min | | | | | |
| Treated: | 1 | 1 | 1 | 1 | NA |
| 190° C./ | | | | | |
| 7 min | | | | | |
| Treated: | 1 | 1 | 1 | 1 | 1 |
| 190° C./ | | | | | |
| 10 min | | | | | |

Rating
“1”: no visible damage;
“3”: partial damage;
“5”: severe damage;
“NA”: not tested.

After thermal treatment at temperatures between 110° C. to 150° C. for 10 min, no significant improvement was observed. By increasing the treatment temperature to 160° C. for 7 min or to 190° C. for 5 min, still no noticeable improvement was observed. However, by extending the treatment time to 10 min at 160° C. and to 7 min to 10 min at 190° C., the example 1 film becomes completely resistant to the insect repellent liquid at 74° C. Meanwhile, the resistance to the sunscreen lotion remains optimal, i.e. not adversely affected by the additional treatment.

Change in Optical Properties by Post Treatment

The changes in haze % and transmission % before and after thermal treatment of the example 1 film at 160° C. and 190° C. for 10 min were compared and are reported in Table 4. With thermal treatment, significant improvement in the chemical resistance was obtained, and under the treatment conditions described above, the haze % and transmission % remain basically unchanged. Accordingly, it is proposed that the size of crystals in the treated films remains below the wavelength of visible light.

TABLE 4

| Samples | Haze % | Transmission % | 60 deg gloss |
|---|---|---|---|
| Control | 0.60% | 94.1% | 157 |
| Treated: 160° C./10 min | 0.66% | 94.2% | NA |
| Treated: 190° C./10 min | 0.60% | 94.1% | NA |

“NA”: not tested

Notably, however, by extending the treatment time to more than 30 min at 170° C., the film is slightly yellowed.

Improved Scratch Resistance by Post Treatment

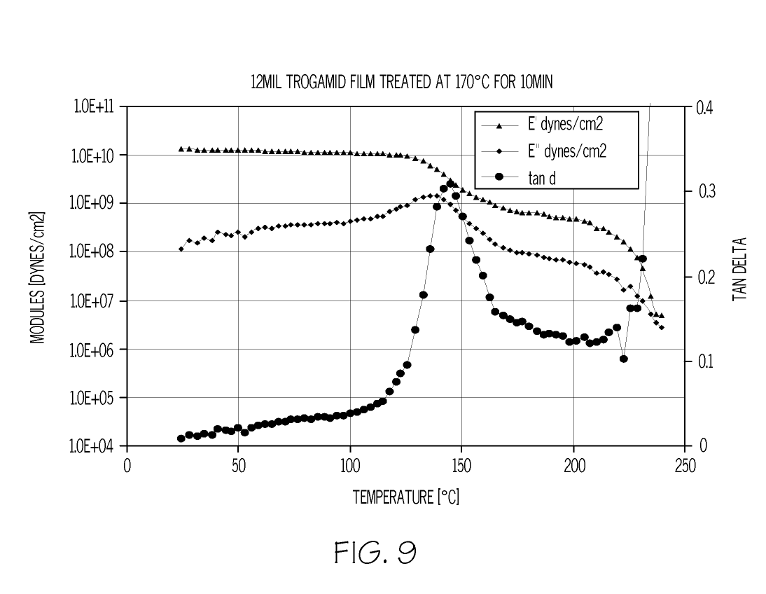

The changes in mechanical properties after treatment are measured by DMA. The E′, E″ and tan-delta for the film treated at 170° C. for 10 min are shown in FIG. 9. Compared to the pristine film, the Tg of the treated film was increased from about 142° C. to about 144° C. due to further crystallization. Hardening of the example 1 film by the post treatment also correlates well with the improved chemical resistance observed above.

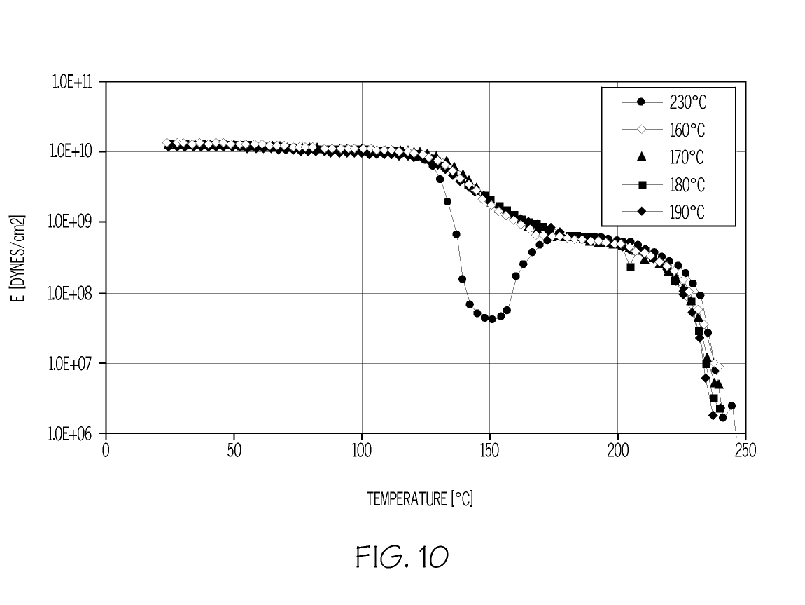

The films treated under different conditions show similar results (see FIG. 10) suggesting that the rearrangement of polymer chains has reached the maximum after 10 min treatment at 160° C.

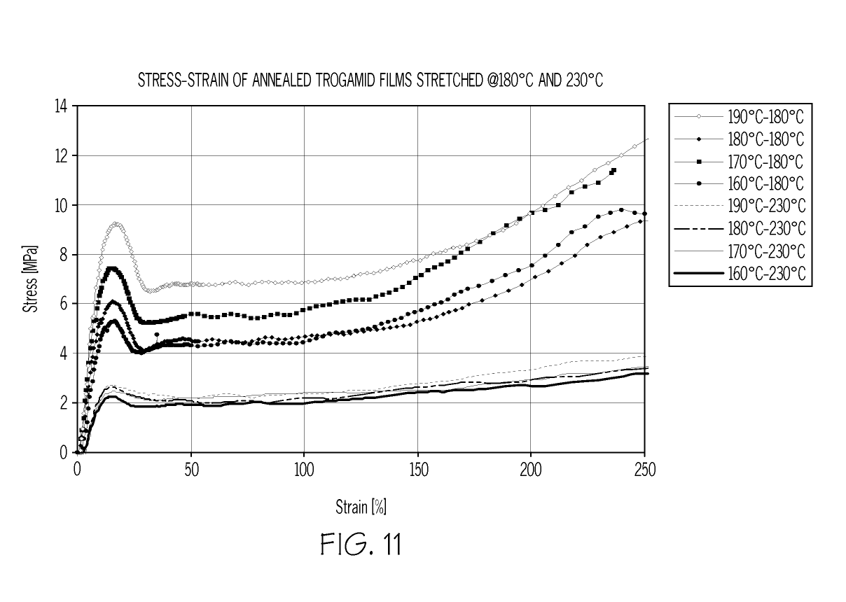

The stress-strain curves at different temperatures were also measured to evaluate the thermoforming performance of the example 1 film after post treatment between 160° C. and 190° C. for 10 min. Compared to the pristine film shown in FIG. 8, the films treated at the aforementioned temperatures show much higher stress and the force exceeded the maximum cell load after about 100% elongation when the test is conducted at 150° C. Because of this, the testing temperatures were increased, to 180° C. and 230° C., respectively. At these temperatures, the film can be elongated to more than 300% (see FIG. 11) without exceeding the maximum cell load. Even after elongation at 300%, the film remains crystal clear and showed negligible shrinkage when the force was released.

The improved chemical resistance of the example 1 film was also observed by thermoforming A 10 mil thick example 1 film was vacuum thermoformed at about 400° F. The resistance to the GMW14445 testing solution was improved from a rating of “3” before thermoforming to “1” after thermoforming.

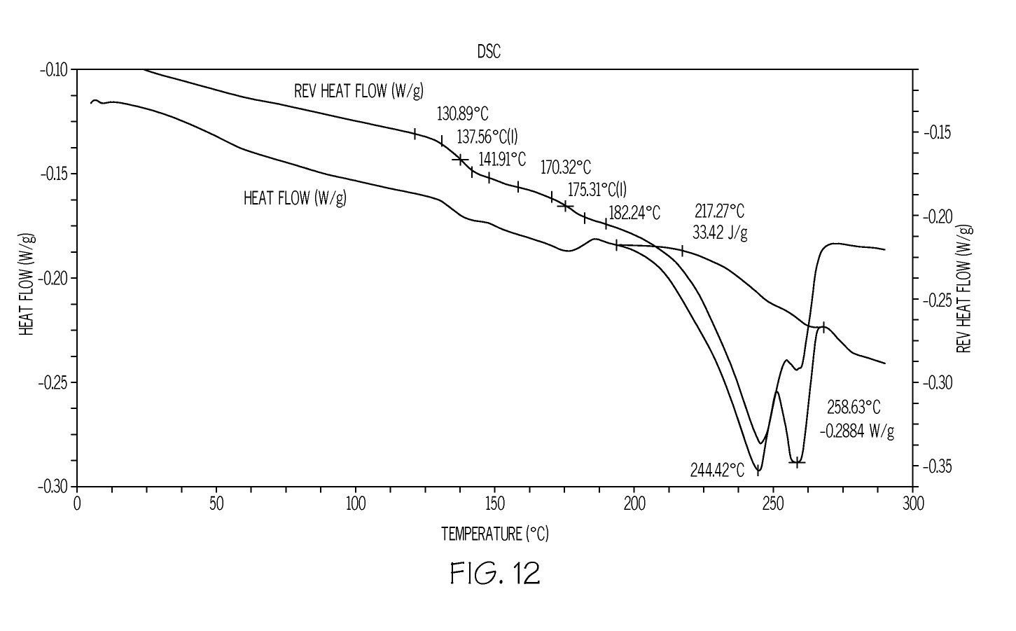

The changes in thermal properties after thermal treatments were measured by DSC. After treatments at 170° C. for 10 min (see FIG. 12), the cold crystallization completely disappeared. In addition, the initial glass transition temperature was increased from about 133° C. to about 138° C. and secondary glass transitions were observed at much higher temperatures, ranging from about 171° C. to about 191° C. depending on the treatment conditions, as reported in Table 5. The pristine film showed a heat of fusion of 16.55 J/g associated with cold crystallization and a total heat of fusion of 32.91 J/g (Table 5). This result indicates that there was only 16.36 J/g heat of fusion for the pristine film before the cold crystallization. After thermal treatment, the cold crystallization disappeared (see FIG. 12) and a heat of fusion of about 30 J/g was measured (Table 5), which indicates the thermal treatment maximized the crystallinity in the film.

TABLE 5

| | Tg | Cold | Heat | | Heat of Fusion |
|---|---|---|---|---|---|
| Samples | (° C.) | Tc (° C.) | (J/g) | Tm (° C.) | (J/g) |
| Control | 133 | 159 | 16.55 | 246 | 32.91 |
| 160° C./10 min | 138 | NA | NA | 243 | 32.73 |
| | 171 | | | | |
| 170° C./10 min | 138 | NA | NA | 244 | 33.42 |
| | 175 | | | | |
| 180° C./10 min | 137 | NA | NA | 245 | 32.82 |
| | 180 | | | | |
| 190° C./10 min | 136 | NA | NA | 244 | 30.77 |
| | 191 | | | | |

### Example 2

### Amorphous PET Film

In another example, the semi-crystalline polymer film 12 was prepared from an amorphous PET or a-PET. Amorphous PET film has high optical clarity and can be easily processed into complex 3D geometries. Because of these properties, a-PET is widely used in food and beverage packaging. Amorphous PET is also one of the most widely recycled plastic materials. Films of different colors are commercially available.

Compared to other semi-crystalline polymers such as polyethylene, polypropylene and example 1, the a-PET crystallizes more slowly so that completely amorphous PET can be obtained by quick quenching from the melt. The crystallization of a-PET film can be induced by heating, stretching or exposure to solvents. In thermal treatment, the crystallization starts around 120° C. which leads to dramatic changes in thermal and mechanical properties. For example, the glass transition was increased from 67° C. to 81° C. [J. Brandrup, E. H. Immergut, Polymer HandBook, New York, Interscience Publishers, 1966]; the film becomes stiffer, harder, and more resistant to solvents. The nucleation and formation of spherulitic crystals were observed in the treated films [E. A. Collins, J. Bares, F. W. Billmeyer, J R., Experiments in Polymer Science, John Wiley & Sons Inc., New York, 1973].

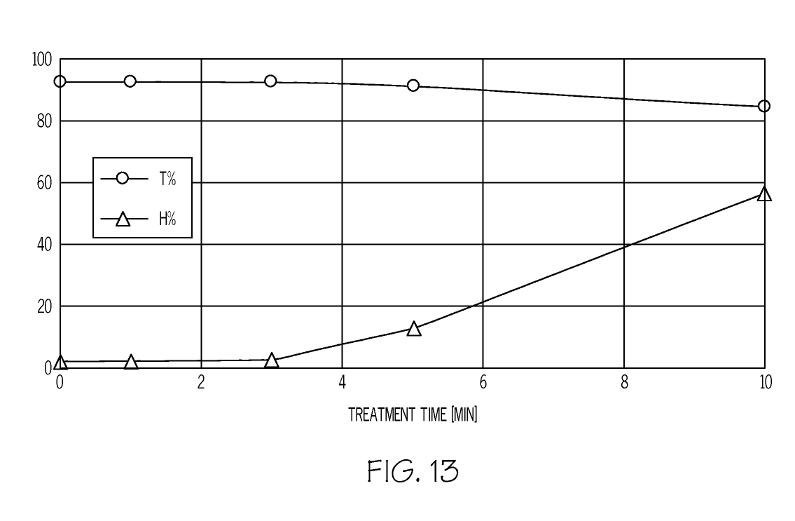

Compared to the example 1 film whose optical properties remain basically unchanged after thermal treatment over a wide range of temperatures and treatment times, the optical properties of amorphous PET film easily change after thermal treatments. An example is shown in FIG. 13 where the changes in optical properties of a 10 mil thick a-PET obtained from Hop Industries treated at 115° C. is illustrated. The film remains clear if the treatment time is less than 3 min, after which the haze % increases almost linearly with the treatment time, reaching more than 50% within 10 min. The increase in haze % is accompanied by a decrease in the transmission %. By increasing the treatment temperature to 120° C., the film becomes translucent after about 5 min and changes to white opaque after 30 min. The changes in the optical properties with treatment conditions imply that the decoration luster of the IMD products made with a-PET as top film can be tuned by the treatment. For example, an initial clear image can be made less visible by treating the a-PET top film for 5 min at 120° C. and no longer visible after treatment for 30 min. and replaced by a solid, white color. If the treatment is conducted only in discrete areas, the decoration luster can be reduced in clarity in the treated areas yet remains visible in the untreated areas.

Improved Chemical Resistance by Post Treatment

The changes in the resistance to insect repellent and sunscreen lotion after treatment at 120° C. for 5 min are listed in Table 6. The pristine a-PET film shows excellent resistance to the sunscreen liquid, even at high temperatures. The a-PET film is also resistant to the insect repellent liquid at room temperature. However, a tree-like pattern was developed on the top surface after testing at 74° C. for 1 hr., due, most probably, to crystallization induced by the ingredients in the insect repellent liquid. By treating the a-PET film at 120° C. for 10 min where the film becomes white opaque, the PET film becomes fully resistant to the insect repellent liquid.

TABLE 6

| | | | | | Treated PET: |
|---|---|---|---|---|---|
| Samples & | Pristine a-PET | | | | 120° C./10 min |
| testing | 23° C. | | 74° C. | | 74° C. |
| conditions | DEET | Sunscreen | DEET | Sunscreen | DEET |
| Rating | 1 | 1 | 3 | 1 | 1 |

Improved Scratch Resistance by Post Treatment

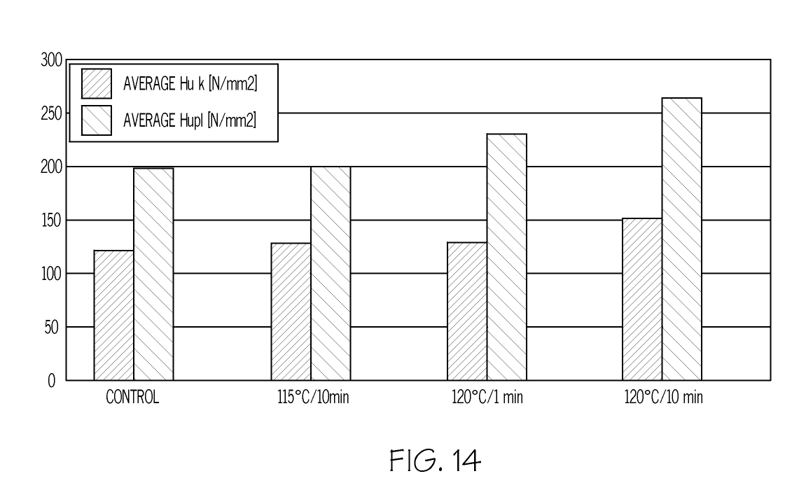

The change in the micro-hardness of the a-PET after thermal treatment at different conditions is plotted in FIG. 14. The average hardness expressed in both Hu k and Hu pol are increased after thermal treatments, particularly at 120° C. where the recrystallization starts. The Pencil hardness of the film was increased from “B” to “H” after thermal treatment at 125° C. for 5 min. Higher hardness leads to better scratch resistance.

### Example 3

### Decoration Laminates Made Using Example 1 as a Top Film

A 12 mil thick example 1 film was used in example 3. In particular, the film material was TROGAMID®, obtained from Evonik Degussa. The film contained a UV absorber for improved resistance to UV radiations. Such film shows 60 degree gloss value of 157 as measured using a Gardener micro-gloss meter. A primer solution was prepared by dissolving 6.0 g of polyurethane resin (ESTANE® 5715, Noveon inc.) in 94.0 g of cyclohexanone solvent. A solvent based gravure printable black-colored ink (L62543) was obtained from Avery Performance Film Division. An adhesion promoting solution was prepared by mixing 6.0 g of 3-Aminopropyltriethoxy-silane (Sigma Aldrich) in 30.0 g of absolute ethyl alcohol (Sigma Aldrich). The adhesion promoting solution was mixed with the gravure ink in a 1 to 4 weight ratio. A continuous primer layer was first printed onto the top film by gravure printing using the primer solution using a lab scale K Printing Proofer and dried at 100° C. for 10 min. A continuous ink layer was gravure printed onto the primed surface using the lab scale K Printing Proofer and dried again at 100° C. for 10 min. The thus printed surface shows a 60 degree gloss of about 91. The printed film was thermally laminated to a 17 mil thick brown color ABS film obtained from Avery Performance Film Division. The ABS film is completely opaque with an optical density close to 6.0 as measured using a Hunterlab ColorQUEST Spectrocolorimeter (Hunter Associates Laboratory, Inc.). A PET protective film of 2 mil in thickness (Melinex® PET, DuPont) was placed over the unprinted surface of the top film to protect this latter from damaging by the lamination rollers. The lamination was performed at temperatures from 340° F. to 360° F., a pressure of 30 Psi and a speed of 0.5 mm/sec. After cooling down to room temperature, the PET protective film was peeled off and a decoration laminate was obtained. The 60 degree gloss of the laminate is greater than 90.

### Example 4

### Decoration Laminates Made Using a-Pet as Top Film

A 10 mil thick a-PET film obtained from Hop Industries Corp. (Garfield, N.J.) was obtained. The film is glossy on both the first and second major surface. The film shows a haze value of 2.3% and an optical transmission of 92.7% as measured using the Gardener Haze-Guard-Plus instrument and a 60 degree gloss value of 150. A black-colored woodgrain image was printed onto the a-PET surface using the K Printing Proofer instrument and a black colored gravure printing ink (L62543) obtained from Avery Performance Film Division. The printed sample was dried in a thermal oven at 60° C. for 10 min. The 60 degree gloss of such decoration laminate was 136. After drying, two layers of solid color background were printed and dried, one at a time, over the woodgrain layer to build a woodgrain image. The 60 degree gloss of the new laminate was close to 100.

What is claimed is:

1. An In-Mold Decoration laminate comprising a top film and a decorative luster pattern, wherein the top film is a semi-crystalline polymer selected from the group consisting of an aliphatic cyclic polyamide, aromatic polyamide, and polyester.

2. The In-Mold Decoration laminate according to claim 1 wherein, the semi-crystalline polymer film is partially crystallized before being subject to a post process treatment.

3. The In-Mold Decoration laminate according to claim 1 wherein, the semi-crystalline polymer film is totally amorphous before being subject to a post process treatment.

4. The In-Mold Decoration laminate according to claim 1 wherein, the crystallinity or content of the semi-crystalline polymer film increases significantly after a post treatment.

5. The In-Mold Decoration laminate according to claim 1 wherein, the semi-crystalline polymer film is made from reaction cycloaliphatic diamine with dodecanedioic acid monomers.

6. The In-Mold Decoration laminate according to claim 1 wherein, the semi-crystalline polymer film is amorphous PET.

7. The decoration laminate according to claim 1 wherein, the semi-crystalline polymer film is a clear film.

8. The decoration laminate according to claim 1 wherein, the semi-crystalline polymer film is a colored film.

9. The decoration laminate according to claim 1 wherein, the semi-crystalline polymer film is a smooth film.

10. The decoration laminate according to claim 1 wherein, the semi-crystalline polymer film is a textured film.

11. The decoration laminate according to claim 1 wherein, the semi-crystalline film consists of a multilayer laminate.

12. The decoration laminate according to claim 1 wherein, the thickness of the semi-crystalline film is less than 1 mil.

13. The decoration laminate according to claim 1 wherein, the thickness of the semi-crystalline film is less than 5 mil.

14. The decoration laminate according to claim 1 wherein, the thickness of the semi-crystalline film is less than 10 mil.

15. The decoration laminate according to claim 1 wherein, the thickness of the semi-crystalline film is less than 20 mil.

16. The decoration laminate according to claim 1 wherein, the thickness of the semi-crystalline film is up to 5 mm.

17. The decoration laminate of claim 1 wherein, the semi-crystalline film is made by extrusion.

18. The decoration laminate of claim 1 wherein, the semi-crystalline polymer film is made by solvent coating onto a polymer carrier.

19. The decoration laminate of claim 1 wherein, the semi-crystalline polymer film is made by solvent casting.

20. The decoration laminate according to claim 10 wherein, the texture is made by printing.

21. The decoration laminate according to claim 10 wherein, the texture is made by embossing.

22. The decoration laminate according to claim 10 wherein, the texture is made by etching.

23. The decoration laminate according to claim 10 wherein, the texture is made by replication.

24. The decoration laminate according to claim 10 wherein, the texture is made by mechanical brush.

25. The decoration laminate according to claim 11 wherein, the semi-crystalline polymer multilayer film is made by adhesive.

26. The decoration laminate according to claim 11 wherein, the semi-crystalline polymer multilayer film is made by co-extrusion.

27. The decoration laminate according to claim 11 wherein, the semi-crystalline polymer multilayer film is made by extrusion onto a polymer substrate film.

28. The decoration laminate of claim 1 further includes a thermoplastic layer.

29. The thermoplastic layer of claim 28 wherein the thermoplastic layer is made of ABS.

30. The thermoplastic layer of claim 28 wherein the thickness of the thermoplastic layer is less than 5 mil.

31. The thermoplastic layer of claim 28 wherein the thickness of the thermoplastic layer is less than 20 mil.

32. The thermoplastic layer of claim 28 wherein the thermoplastic layer is clear.

33. The thermoplastic layer of claim 28 wherein the thermoplastic layer is colored.

34. The decoration laminate of claim 28 wherein, the thermoplastic layer is attached to the decoration luster pattern by thermal lamination.

35. The decoration laminate of claim 28 wherein, the thermoplastic layer is attached to the decoration luster pattern by an adhesive.

36. The decoration laminate of claim of 1 further includes a carrier film on the top surface of the semi-crystalline film.

37. The carrier film of claim of 36 wherein, the carrier film is a polyester film.

38. The carrier film of claim of 36 wherein, the carrier film is a polyamide film.

39. The carrier film of claim 36 wherein, the carrier film is thermoformable.

40. The carrier film of claim 36 wherein, the carrier film is smooth.

41. The carrier film of claim 40 wherein, the surface roughness of the carrier film is less than 15 nm.

42. The carrier film of claim 40 wherein, the surface roughness of the carrier film is less than 30 nm.

43. The carrier film of claim 40 wherein, the surface roughness of the carrier film is less than 100 nm.

44. The carrier film of claim 35 wherein, the carrier film is textured.

45. The decoration laminate of claim 4 wherein, the treatment is conducted over the entire surface.

46. The decoration laminate of claim 4 wherein, the treatment is conducted in discrete areas.

47. The decoration laminate of claim 4 wherein, the treatment depth ranges from the top surface toward and up to the bottom surface.

48. The decoration laminate of claim 4 wherein, the treated areas rise above the plane of the film.

49. The decoration laminate of claim 4 wherein, the treated areas are below the plane of the film.

50. The decoration laminate of claim 4 wherein, the treatment consists of thermal treatment.

51. The decoration laminate of claim 4 wherein, the treatment consists of solvent treatment.

52. The decoration laminate of claim 4 wherein, the treatment consists of plasma treatment.

53. The decoration laminate of claim 4 wherein, the treatment consists of laser treatment.

54. The decoration laminate of claim 4 wherein, the treatment is made before printing of decoration luster.

55. The decoration laminate of claim 4 wherein, the treatment is made during printing of decoration luster.

56. The decoration laminate according to claim 4 wherein, the treatment is conducted after printing of decoration luster but before in-mold processing.

57. The decoration laminate according to claim 4 wherein, the treatment is conducted during in-mold processing.

58. The decoration laminate according to claim 4 wherein, the treatment is conducted after in-mold processing.

59. The film of claim 1, wherein the film can be elongated to up to 50% at the processing temperature.

60. The film of claim 1, wherein the film can be elongated to up to 100% at the processing temperature.

61. The film of claim 1, wherein the film can be elongated to up to 200% at the processing temperature.

62. The film of claim 1, wherein the film can be elongated to up to 300% at the processing temperature.

63. The decoration laminate according to claim 1 wherein, the decoration luster pattern is printed by conventional printing methods.

64. The decoration laminate according to claim 1 wherein, the decoration luster pattern is printed by digital printing methods.

65. The decoration laminate according to claim 59 wherein, the decoration luster pattern is printed by laser etching.

66. The decoration laminate according to claim 59 wherein, the decoration luster pattern is printed by dye-sublimation.

67. A method of creating a decoration laminate including the steps of:
preparing a semi-crystalline polymer film;
printing a decoration luster pattern on the bottom surface of the semi-crystalline polymer film;
optimizing the crystallinity structure of the semi-crystalline polymer film.
